(19) United States
(12) Patent Application Publication
(10) Pub. No.: US 2013/0021165 A1
(43) Pub. Date: Jan. 24, 2013

(54) ELECTRONICS MODULE FOR USE SUBSEA

(71) Applicant: Martin STOKES, Newport (GB)

(72) Inventor: Martin STOKES, Newport (GB)

(21) Appl. No.: 13/554,630

(22) Filed: Jul. 20, 2012

(30) Foreign Application Priority Data
Jul. 21, 2011 (EP) 11174875.2

(51) Int. Cl. H04B 13/02

(52) U.S. Cl. 340/850

(57) ABSTRACT

An electronics module for use subsea is provided. The electronics module comprises a vibration sensor on a printed circuit board in the electronics module. the vibration sensor being configured to sense vibration of the electronics module. The module is typically a subsea electronics module for use in a control system for a subsea hydrocarbon extraction well facility.

### BACKGROUND OF THE INVENTION

Embodiments of the invention relate to an electronics module for use subsea, for example a subsea electronics module for use in a control system for a hydrocarbon extraction well facility.

In offshore oil and gas production control systems, much of the equipment is mounted on a tree, installed on the seabed. The main equipment of a typical system configuration includes: a master control station (MCS), which provides the operator interface with subsea equipment and displays the current state of various subsurface equipment, subsea valves and sensor information enabling the operator to control the system; an umbilical cable, which connects the MCS to the equipment installed on the seabed and incorporates a communication link which carries control signals to the subsurface equipment and transfers information on the status of the subsurface equipment to the MCS; a subsea control module (SCM), which receives commands from the MCS and controls all the subsea processes, provides the hydraulic power to actuate valves and transmits status data on subsea equipment and sensor data to the MCS; a subsea electronics module (SEM), housed within the SCM and which is a microprocessor based electronics unit that houses a set of printed circuit boards (PCBs), the functions of which include communication with the MCS (receiving control information from, and transmitting sensor data to, the MCS), interfacing with subsurface sensors and controlling valves and hydraulics; and a tree installed on the seabed, to which is fitted the subsurface electric and hydraulic equipment needed to control the flow of fluid from the well together with a sensor pack, to determine the state of the Christmas tree equipment, well head components and fluid flowing from the well.

The sensor pack usually includes at least one dedicated vibration sensor which detects vibrations of the tree and equipment mounted on it. Such a sensor requires its own power, communication, cables and connectors to get the data to the SEM. However, the accuracy of this data in relation to the vibrations sensed by actual equipment (for example that housed in the SCM) is not necessarily good.

### BRIEF DESCRIPTION OF THE INVENTION

According to an embodiment of the present invention, there is provided an electronics module for use subsea, the module comprising a vibration sensor on a printed circuit board in the module, the vibration sensor being configured to sense vibration of the module.

According to another embodiment of the present invention, there is provided a control system for a subsea hydrocarbon extraction well facility. The control system comprises an electronics module comprising a vibration sensor on a printed circuit board in the electronics module, the vibration sensor being configured to sense vibration of the electronics module, wherein the electronics module is arranged in a subsea control module at a tree of the facility.

According to another embodiment of the present invention, there is provided a method of monitoring vibration of an electronics module used subsea. The method comprises providing the electronics module with a vibration sensor on a printed circuit board in the electronics module to sense vibration of the electronics module.

The electronics module may be a subsea electronics module for use in a control system for a subsea hydrocarbon extraction well facility.

In an exemplary embodiment of the invention, the sensor comprises a three-axis acceleration sensor.

In an exemplary embodiment of the invention, the sensor is incorporated in an integrated circuit. In this case, the integrated circuit typically includes means for amplifying and processing signals from the sensor.

A control system for a subsea hydrocarbon extraction well facility, including a module according to embodiments of the present invention, in a subsea control module at a tree of the facility, is also provided. In this case the system includes means for transmitting data from the sensor to a further location such as a master control station or automatic test equipment.

### BRIEF DESCRIPTION OF THE DRAWINGS

FIG. 1 schematically shows the configuration of a control system for a hydrocarbon extraction well incorporating the embodiments of the invention.

### DETAILED DESCRIPTION OF THE EXEMPLARY EMBODIMENTS OF THE INVENTION

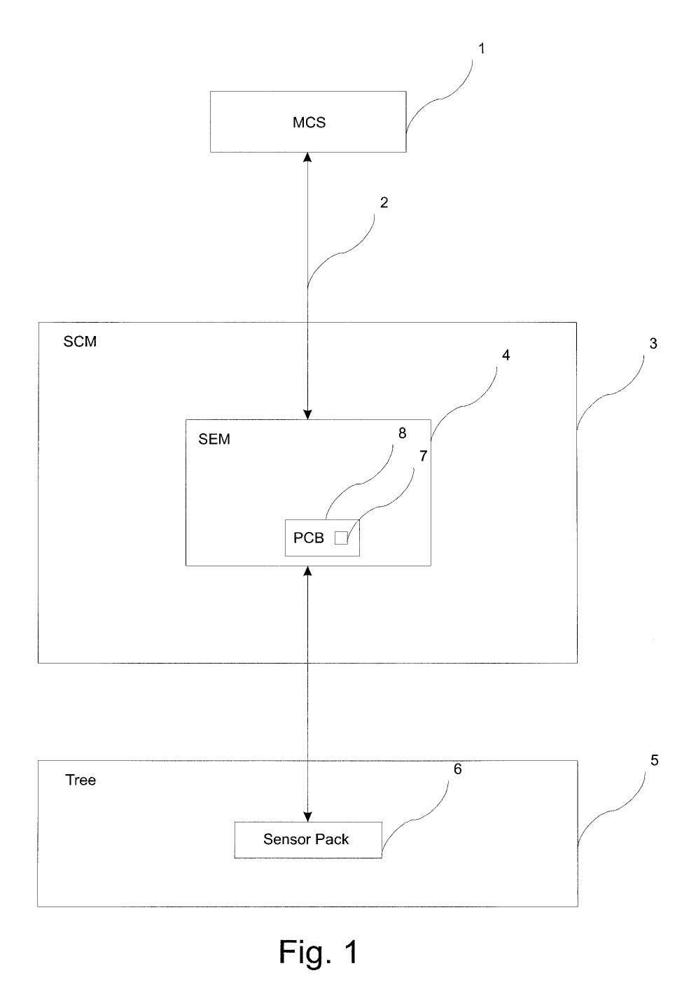

FIG. 1 shows schematically the above described configuration of a control system for a hydrocarbon extraction well facility but incorporating embodiments of the invention. Reference numeral 1 designates an MCS; reference numeral 2 designates an umbilical cable; reference numeral 3 designates an SCM; reference numeral 4 designates an SEM: reference numeral 5 designates a tree; and reference numeral 6 designates a sensor pack.

The SCM 3 is a self-contained, sealed unit having a steel casing and a metal baseplate which is fixed to the tree 5 by a series of bolts. The SEM 4, which is itself a heavy metal unit, is securely integrated inside the SCM 3.

However, in contrast to what is described above, the sensor pack 6 does not include the above-mentioned dedicated vibration sensors. Instead, this embodiment of the invention entails mounting an integrated circuit (IC) 7, which incorporates a three-axis vibration sensor, on a PCB 8 fitted into the SEM 4. The IC 7 is mechanically fixed to the PCB 8 by sufficiently rugged electrical connectors and the PCB 8 itself is designed with four faces of mechanical registration and fits into sufficiently rugged electrical connectors fixed to the SEM structure, so that the forces sensed by the vibration sensor of IC 7 will bear a very direct relationship to the Forces applied to the SEM 4 itself.

100151 The IC 7, more particularly, is an IC which includes a three-axis accelerometer and which can be mounted on a PCB 8 and interlace directly with it. The IC 7 turns sensed mechanical acceleration forces, via an amplifier circuit and an analogue to digital converter in the IC 7, into a data format, which is transmitted via a communications link (for example in the umbilical cable 2) to the MCS 1 or to automatic test equipment (ATE) during testing and qualification.

This design approach differs from the conventional method of physically mounting a vibration sensor directly on a tree and eliminates the need for external cables and connectors carrying communications and electrical power to the externally mounted vibration sensor and provides a more accurate measurement of equipment vibration.

Some technical advantages enabled by the invention are: removal of the need for a vibration sensor to be mounted in a subsea environment directly on a tree: an increase in the overall system reliability due to the elimination of cables and connectors in a subsea environment (which are common points of failure); and the provision of more accurate measurements of equipment (e.g. an SEM) vibration than from a tree mounted sensor.

An additional benefit is that the sensor can be used to improve the environmental stress screening (ESS) of an SEM and also be used for SEM qualification testing. Currently, large external sensors are mounted onto an SEM or cards within it which sensors can artificially skew the results. By having a board mounted sensor, the actual vibration to which the board is subjected can be accurately sensed.

Embodiments of the present invention could also be useful in subsea drilling control systems as well as production systems.

Information retrieved can be used to design an improved and more rugged SEM if needed.

Some commercial advantages enabled by the invention are: a reduction in equipment cost as external cables and connectors are not needed; improved reliability, resulting in reduction in overall lifecycle costs; the use of more accurate vibration data as part of equipment state of health assessment and improved planned maintenance routines, contributing to reduced costs; and reducing the need and costs of large external sensors for the purpose of SEM testing and qualification.

What is claimed is:

1. An electronics module for use subsea, the electronics module comprising a vibration sensor on a printed circuit board in the electronics module, the vibration sensor being configured to sense vibration of the electronics module.

2. The electronics module according to claim 1, wherein the electronics module is a subsea electronics module for use in a control system for a subsea hydrocarbon extraction well facility.

3. The electronics module according to claim 1, wherein the vibration sensor comprises a three-axis acceleration sensor.

4. The electronics module according to claim 1, wherein the vibration sensor is incorporated in an integrated circuit.

5. The electronics module according to claim 4, wherein the integrated circuit is configured to amplify and process signals from the sensor.

6. A control system for a subsea hydrocarbon extraction well facility, the control system comprising an electronics module comprising a vibration sensor on a printed circuit board in the electronics module, the vibration sensor being configured to sense vibration of the electronics module, wherein the electronics module is arranged in a subsea control module at a tree of the facility.

7. The system according to claim 6, the system configured to transmit data from the sensor to a further location.

8. A method of monitoring vibration of an electronics module used subsea, the method comprising providing the electronics module with a vibration sensor on a printed circuit board in the electronics module to sense vibration of the electronics module.

9. The method according to claim 8, wherein the electronics module is a subsea electronics module of a control system for a subsea hydrocarbon extraction well facility.

10. The method according to claim 8, wherein the vibration sensor comprises a three-axis acceleration sensor.

11. The method according to claim 8, wherein the vibration sensor is incorporated in an integrated circuit.

12. The method according to claim 11, wherein the integrated circuit amplifies and processes signals from the vibration sensor.

13. The method according to claim 9, wherein the module is in a subsea control module at a tree of the facility.

14. The method according to claim 8, further comprising transmitting data from the vibration sensor to a further location.
